(19) United States
(12) Patent Application Publication
(10) Pub. No.: US 2015/0338718 A1
(43) Pub. Date: Nov. 26, 2015

(54) ACOUSTO-OPTIC DEFLECTOR WITH MULTIPLE TRANSDUCERS FOR OPTICAL BEAM STEERING

(71) Applicant: INTEL CORPORATION, Santa Clara, CA (US)

(72) Inventors: Chong ZHANG, Chandler, AZ (US); Aleksandar Aleksov, Chandler, AZ (US); Islam A. Salama, Chandler, AZ (US); Tiansi Wang, Orlando, FL (US); Aravinda Kar, Orlando, FL (US)

(21) Appl. No.: 14/690,341

(22) Filed: Apr. 17, 2015

Related U.S. Application Data
(63) Continuation of application No. PCT/US2014/039247, filed on May 22, 2014.

(51) Int. Cl. G02F 1/33

(52) U.S. Cl. CPC G02F 1/33

(57) ABSTRACT

An acousto-optic deflector with multiple acoustic transducers is described that is suitable for use in substrate processing. In one example a method includes transmitting an optic beam through an acousto-optic deflector, applying an acoustic signal with a phase delay across multiple transducers of the acousto-optic deflector to deflect the beam along a first axis by the acousto-optic deflector, and directing the deflected beam onto a workpiece.

### CROSS REFERENCE TO RELATED APPLICATION

This patent application is a continuation of and claims priority to PCT International Application No. PCT/US2014/039247, filed Mar. 22, 2014, entitled ACOUSTO-OPTIC DEFLECTOR WITH MULTIPLE TRANSDUCERS FOR OPTICAL BEAM STEERING.

### FIELD

The disclosure relates to a method and a system for configuration and operation of acousto-optic deflectors for optical beam scanning.

### BACKGROUND

Industrial lasers are used for a wide variety of different purposes in the manufacture and processing of components. The usefulness of the laser is improved by steering the light beam produced by the laser so that the beam can be steered to hit very specific locations on a workpiece. In semiconductor processing, lasers are used for diagnostic scanning, for drilling, for pattern imaging and for other purposes.

In integrated circuit design, for example, a via is a small opening in an insulating dielectric layer that allows a conductive connection between conductive parts of two different layers. Typically a laser beam is steered by mechanical movements of mirrors in a galvanometer based system to drill vias at specific locations on an insulating dielectric layer or some other material. An optical scanner may be used to position a laser or other type of optical beam for a broad range of industrial, scientific, imaging, and laser applications.

The speed at which a galvanometer based laser beam steering system can operate is limited by the mechanical construction of the mirror mounts and the galvanometer that drives the mirror mounts. The mechanical minor drive system also limits the accuracy at which the laser beam can be positioned on a workpiece.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1 is a block diagram of an AOD to show principles of adjusting deflection using acoustic waves;

FIG. 2 is a block diagram of an AOD to show principles of adjusting deflection using phase delayed acoustic waves according to an embodiment;

FIG. 3 is another block diagram of an AOD to show principles of adjusting deflection using phase delayed acoustic waves according to an embodiment;

FIG. 4 is another block diagram of an AOD to show principles of adjusting deflection using phase delayed acoustic waves that occupy the entire AOD crystal width according to an embodiment;

FIG. 5A is an isometric partially cut away block diagram of an AOD to show principles of adjusting deflection using phase delayed acoustic waves in two dimensions according to an embodiment;

FIG. 5B is another isometric partially cut away block diagram of an AOD to show principles of adjusting deflection using phase delayed acoustic waves in two dimensions according to an embodiment;

FIG. 5C illustrates an AOD crystal with two adjacent angled faces, each of the two faces having an acoustic transducer array;

FIG. 6 is a diagram of a workpiece processing system using a laser source and an AOD according to an embodiment; and

FIG. 7 is a process flow diagram of steering an optic beam using an AOD according to an embodiment.

### DETAILED DESCRIPTION

An optical beam, for example a laser beam may be steered by transmitting it through a material that is responsive to acoustic waves. The refractive index of the material changes due to an acousto-optic interaction. Acoustic waves through the material produce a periodic mechanical stress. The stress creates alternating compressions and rarefactions in the atomic density of the material. This change in density causes a periodic variation in the refractive index around its nominal unstressed value, which forms a transmission grating region in the material. An incident light beam propagating through the material is deflected by Bragg diffraction within the transmission grating region.

Such an acousto-optic deflector may be used to steer a laser beam. In the operation of an acousto-optic deflector, the power driving the acousto-optic deflector may be kept at a constant level, while the acoustic frequency is varied to deflect the laser beam to different angular positions. Alternatively, the acoustic power can be changed to change the diffraction efficiency of the AOD and thereby modulate the output laser energy to a different deflecting angle. In an acousto-optic deflector, changes in the angle of direction and the angular position of the laser beam is linearly proportional to the acoustic frequency. If the acoustic frequency is higher, then the diffracted angle is larger.

For many steered beam applications, the beam must be steered in two directions. For laser drilling on a semiconductor substrate, vias may be desired in many different positions on the surface of the substrate. In order to reach all of the desired positions, either the beam must be steered across the surface of the substrate in two directions or if the beam can only be steered in one direction, then the substrate must be moved in the other direction to allow the beam to reach the whole surface of the substrate.

In order to provide two degrees of motion for the beam two acousto-optic deflectors may be used one for each direction. The two acousto-optic defectors may be configured for laser scanning, micromachining, imaging, device inspection and other applications instead of via drilling. In many applications the use of two deflectors increases the complexity and the size of the beam steering system.

As described herein a single acousto-optic deflector (AOD) may be used to provide beam steering in two directions simultaneously. The Bragg condition may be created 3-dimensionally to achieve perfect beam steering. Acoustic waves produced by multiple micro transducers generate an interfered pattern with an acoustic propagation vector in a certain angle in an AOD crystal. By changing the phase delay between two or more transducers that are orthogonal, adjacent or both, acoustic wave beam steering can be realized. The acoustic wave beam steering may be set to match an RF (radio frequency) of the crystal, so that the Bragg condition for each deflection angle at a certain RF frequency (f) can be met. The pitch and transducer array pattern are aligned for acoustic interference for 2D laser beam scanning. A large deflection scan angle (AO) and high efficiency (ii) can be achieved with such an optimization.

A two-dimensional interfered AOD beam steering system offers fast response time, high scanning speeds, a wide range of scan angles, and it avoids the difficulties with alignment and positional drift that can occur with galvanometer mirror systems.

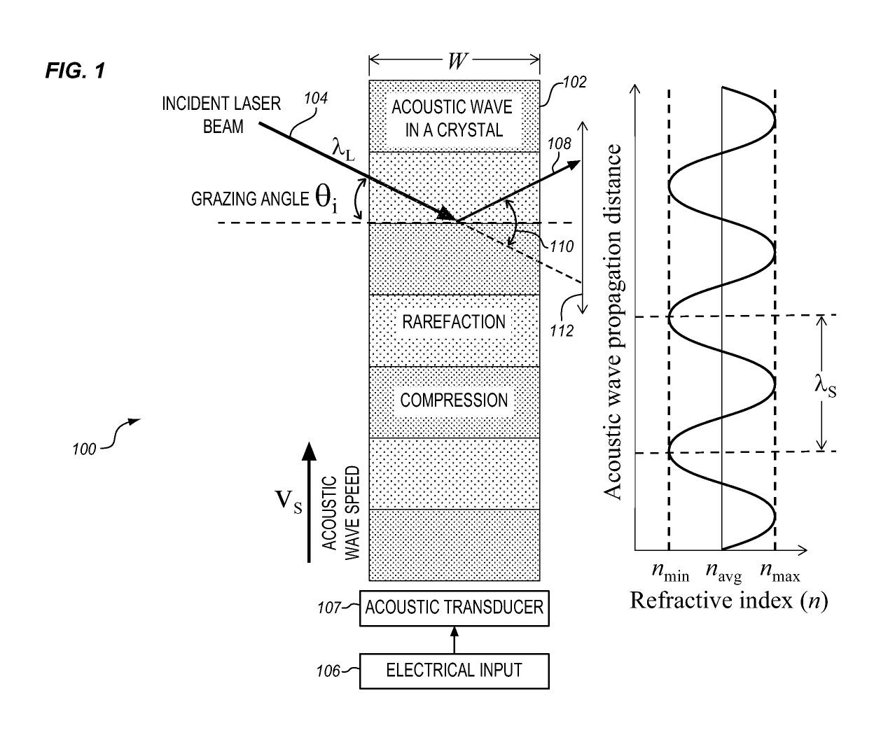

FIG. 1 is a ray trace diagram of a laser beam propagating through an acousto-optic deflector 102. For simplicity, only one direction of deflection is shown, the vertical direction as shown on the drawing sheet. The AOD generates an adjustable diffracted beam.

A laser beam 104 is incident on the acousto-optic deflector 102, where the laser beam 104 is referred to as an incident laser beam. Based on electrical inputs 106 applied to electrical to mechanical transducers 107 and then to the acousto-optic deflector 102, the incident laser beam 104 undergoes diffraction within the acousto-optic deflector and a diffracted laser beam 108 is generated. The diffraction angle 110, i.e. the angle between the diffracted laser beam 108 and the incident laser beam 104 is determined by the acoustic frequency or power applied by transducers. The transducers are placed between the electrical input and the deflector crystal 102.

The efficiency for the first order diffracted laser beam is improved when the laser beam is diffracted under the Bragg condition, which is given by λ_{L}=2λ_{S} sinθᵢ, where λ_{L} and λ_{S} are the wavelengths of the laser beam and the acoustic wave inside the acousto-optic crystal, respectively, and θᵢ, is the grazing angle of the incident laser beam inside the acousto-optic crystal, i. e., the angle subtended by the incident laser beam with the interface of the compressed and rarefied layers of the phase grating inside the acousto-optic crystal as shown in FIG. 1.

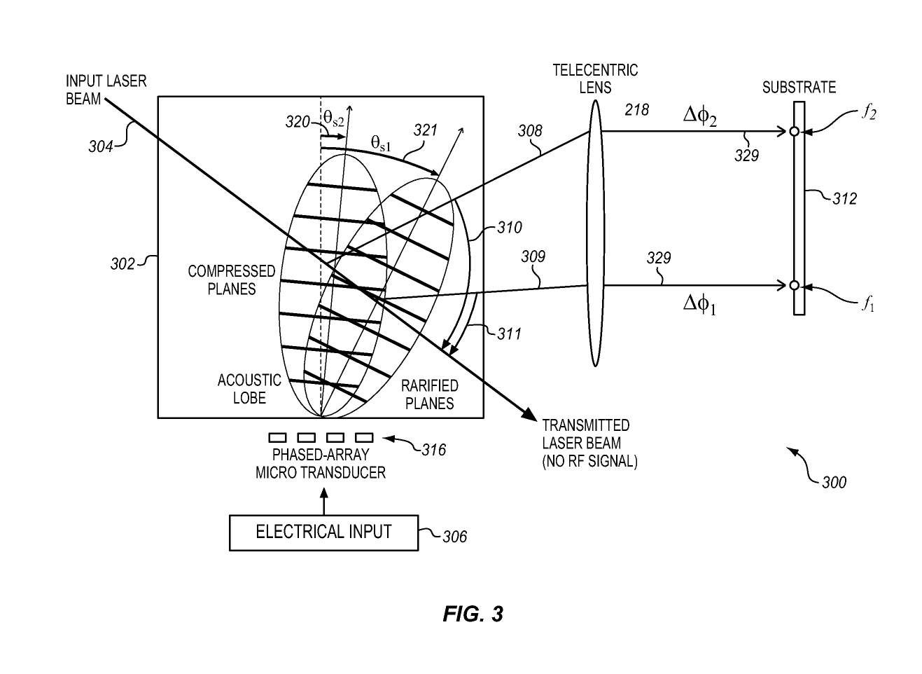

The wavelength of the acoustic wave inside the acousto-optic crystal, λ_{S}, represents the periodicity of the phase grating shown in FIG. 1. Since the grazing angle, θᵢ, will vary as the steering angle (as shown in FIG. 3), θ_{S}, i. e., the inclination of the acoustic lobe, varies to achieve large deflections of the incident laser beam; the periodicity of the phase grating in the acoustic lobe can be modulated to induce the deflection of the laser beam under the Bragg condition.

Since λ_{S}=Vₛ/fₛ, where V_{Ss} and fₛ are the velocity and frequency of the acoustic wave inside the acousto-optic crystal, the Bragg condition can be rewritten as λ_{L}=2(Vₛ/fₛ)sinθᵢ, which indicates that the velocity or frequency or a combination thereof can be modulated to induce the deflection of the laser beam under the Bragg condition when θₛ varies. The wave speed, Vₛ, is constant in isotropic crystals, but Vₛ varies with the angular direction in anisotropic crystals. Therefore, an anisotropic crystal-based acousto-optic deflector can be used to utilize the variation of Vₛ with the angle, such as θₛ, for inducing the deflection of the laser beam under the Bragg condition when θₛ varies. Also the transducers can be made to emit acoustic waves of different frequencies by applying appropriate electrical signals to the transducers and, by this mechanism, fₛ can be varied to induce the deflection of the laser beam under the Bragg condition when θₛ varies.

The illustrated AOD 102 deflects the incident laser beam 104 along a single dimension. For example, if the two dimensional surface of a substrate is represented by an X-axis (representing a horizontal direction) and a Y-axis (representing a vertical direction) that are orthogonal to each other, then in an exemplary embodiment, the acousto-optic deflector 102 when placed in a certain position and orientation, may spatially position the diffracted beam in either a vertical direction or a horizontal direction but not both.

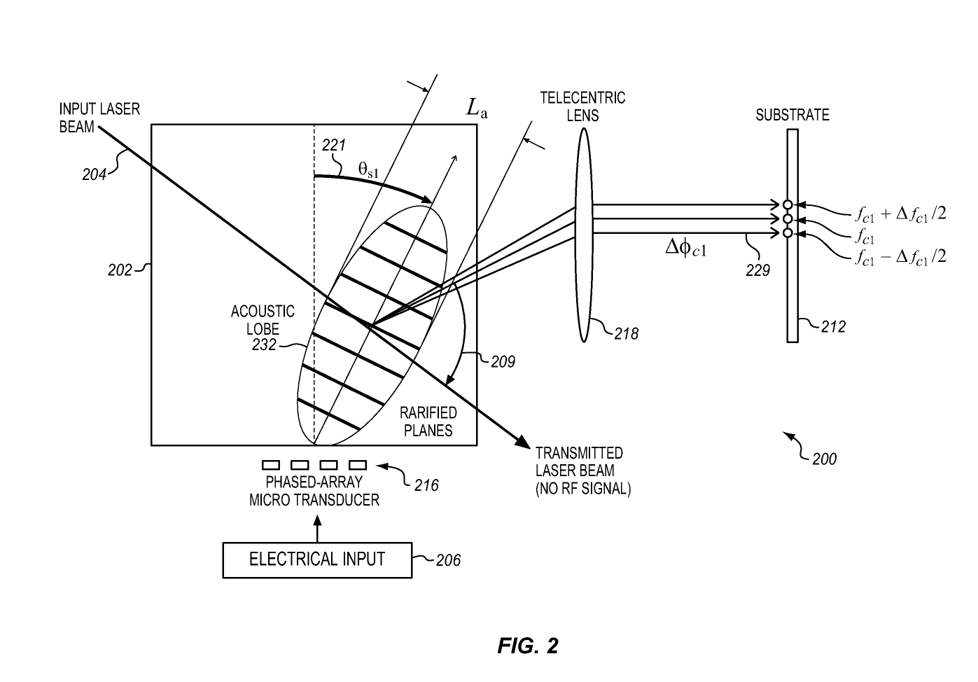

FIG. 2 is a more specific diagram of an AOD with improved performance to optically steer an incident light beam in one direction. In the illustrated example, an incident laser beam 204 is diffracted with a varying RF signal, bandwidth and phase-shift. The beam deflection system 200 is based around an AOD crystal 202. An input optical beam 204, such as a laser is input to the crystal at a selected incident angle. The optical beam is deflected at an angle determined by the crystal and output at any selected output angle, 209 from which it is incident on an optical system 218.

In this example, the optical system is a singlet telecentric lens 218, however, a more complex or more flexible optical system may be used depending on the requirements of a particular system. The telecentric lens refracts the output beam to direct it onto a workpiece 212. The output beam 209 is directed to different positions by the lens to become an incident beam 229 on the workpiece.

The AOD includes an array of transducers 216. The transducers receive an electrical waveform from an electrical input module 206 and apply this waveform to the AOD crystal as an elastic wave or acoustic wave in the crystal material. The array of transducers is distributed across a surface of the AOD. In the illustrated example, the transducers are attached to the horizontal bottom of the crystal and the input laser beam 204 is incident on the adjacent orthogonal vertical side wall.

As the acoustic waves propagate through the crystal compressed and rarefied waves, which could be standing or propagating waves depending on the design of the top surface of the crystal, are established in the crystal. The acoustic waves may be steered by adjusting the phase delay between the transducers. An acoustic lobe 232 is established along an acoustic steering angle using a phase delay. The acoustic lobe is generated based on a first center frequency f_{c1} applied to the crystal and has an axis offset by a first angle θₛ₁ from the vertical.

The acoustic steering angle θₛ₁ of the acoustic lobe may be switched quickly between the illustrated angle and any other angle by varying the input acoustic phase delay electrical signal to the transducers. The change may occur within microseconds, based on the acoustic wave speed in the crystal generated by the transducers and the elastic response time of the crystal. The elastic response time refers to the characteristic time during which the compressed and rarefied atomic planes return to the normal lattice planes of the crystal.

Any particular acoustic beam steering angle θₛ may be achieved by adjusting the phase delay between neighboring transducers. For the example of an isotropic material, such as germanium crystal and a closely spaced acoustic transducers, a time delay Δτ between neighboring elements can be determined for a desired deflection angle as Δτ=(S×sinθₛ)/cₚ, where S is the distance between adjacent transducers and cₚ is the acoustic velocity of the longitudinal mode of the wave through the acousto-optic deflector. This velocity depends on the physical properties of the crystal. The phase shift Δφ between adjacent transducers can then be determined as Δφ=2 πf×Δτ, where f is the acoustic central frequency. If the transducers are spaced farther apart or for other types of materials, the phase delay may be still be directly calculated using different equations.

The acoustic lobe causes the laser beam 209 from the crystal to deflect by an angle 211 determined by the angle of the acoustic lobe. Small variations Δf_{c1} around the center frequency allow the beam to be steered about this angle to cause the final focused beam 229 to strike the workpiece in different positions. As shown by changing the acoustic frequency electrical signal applied to the transducer, the one optic beam strikes the workpiece in a range of different positions.

In this technique, multiple transducers 216 are used across a surface of the optical crystal. The phase of the acoustic signal used to excite each transducer varies as does the frequency of the signal. Given an acoustic wave phase-shift (Δφ) for the transducers, a central radio frequency (f_{c}) for the transducers and a frequency modulation for the transducers of Δf around f_{c}, the deflection of the incident laser beam can be determined. The laser beam 204 is deflected by varying these three variables f_{c}, Δf and Δφ at the micro transducers.

When a particular Δf is chosen, the laser beam scan angle, Δθ is given by Δθ=(λ₀Δf)/V, which is derived from the Bragg diffraction equation: sinθ_{B}=(λ₀f)/2V. For a given acoustic lobe at the inclination (beam steering) angle of θₛ₁, the compressed and rarefied atomic planes are perpendicular to the direction of acoustic wave propagation. In this arrangement of atomic planes, the laser beam is deflected under the Bragg diffraction condition at the central acoustic frequency f_{c1}, leading to the maximum diffraction efficiency. After deflecting the beam at the acoustic frequency of f_{c1} and the bandwidth of Δf_{c1} around f_{c1}, the acoustic lobe is tilted to another inclination angle θₛ₂. The acoustic lobe now operates at another Bragg diffraction condition corresponding to the center frequency of f_{c2} and bandwidth of Δf_{c2} to do a set of deflection with this acoustic lobe.

FIG. 3 is a diagram of an AOD for laser beam deflection showing two different deflection angles according to an embodiment. FIG. 3 shows how the atomic planes are tilted due to the acoustic wave propagation through the crystal to achieve Δθ around the acoustic beam steering angle θ.

As in FIG. 2, the AOD beam deflection system 300 of FIG. 3 has an AOD crystal 302, with an input laser beam 304 entering the crystal at a particular incident angle. Electrical input 306 drives an array of transducers 316 to generate acoustic waves in the crystal. Two acoustic lobes are shown, the first is canted at an angle θₛ₁ from the vertical causing the laser beam to deflect at a particular angle 311 to exit 309 and be focused by a lens 318 outside of the crystal 302. The focused beam 329 strikes a workpiece 312 at which the beam is directed by the lens. The second acoustic lobe is canted at another angle θₛ₂ from the vertical causing the laser beam to deflect at a particular angle 310 to exit 308 and be focused by the lens 318. The focused beam 328 strikes the workpiece 312 at a different location due to the difference in orientation between the acoustic lobes within the crystal.

A large deflection scan angle (Δθ) and a high diffraction efficiency (η) are obtained while meeting the Bragg condition for each diffraction angle at a certain RF frequency (f). In this second technique, the phase-shift of the acoustic wave (Δφ) at each transducer and the RF frequency (f) are varied. As a result, the laser beam is deflected by varying two variables which are f and Δφ the acoustic wave at the micro transducer.

At a given inclination angle θₛ₁ of the acoustic lobe, the compressed and rarified atomic planes are perpendicular to the direction of acoustic wave propagation. At this inclination angle of θₛ₁, the laser beam is deflected under the Bragg diffraction condition to a particular location on the substrate, which means that the frequency f₁ and Δφ₁ are selected properly to achieve the Bragg diffraction condition at the acoustic lobe inclination angle θₛ₁. To deflect the beam at another location, other values of frequency, f₂, and phase shift, Δφ₂, are selected to create an acoustic lobe at another inclination angle, θₛ₂, to achieve a different laser beam deflection under the Bragg diffraction condition. The minimum difference between the acoustic lobe inclination angles, θₛ₁ and θₛ₂, is related to the deflection scan resolution on the substrate surface.

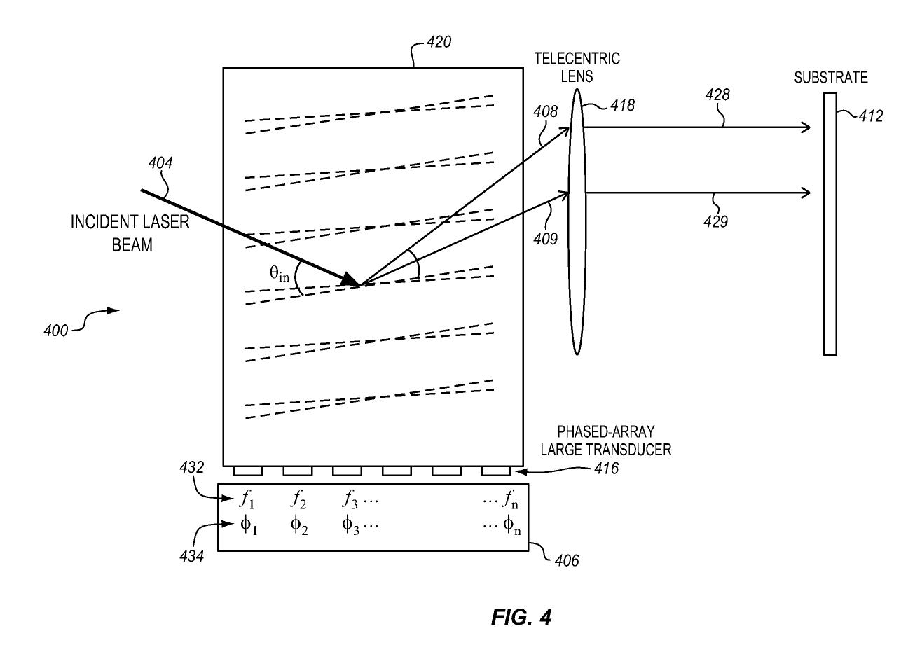

FIG. 4 is a diagram of an AOD system 400 that deflects a beam using a large number of phased array of acoustic transducers in an AOD crystal. An incident laser beam 404 enters an AOD crystal 420 at in incident angle θᵢₙ and exits as a deflected beam 408, 409 at an angle depending on the acoustic lobe that is present in the crystal. The exiting beam 428, 429 is focused by a telecentric lens 418 or other optical imaging system onto a workpiece 412. The AOD crystal 420 has a phased array of large transducers 416 that are powered by an electrical input 406. The electrical input is a waveform with a series 432 of frequencies f₁, f₂, f₃ . . . fₙ and a series 434 of phases φ₁, φ₂, φ₃ . . . φₙ.

The efficiency of the AOD is increased by driving acoustic waves through more of the volume of the crystal. This is done by increasing the amount of the crystal surface that is coupled to acoustic transducers. While it is possible to simply use e.g. four large transducers to cover a surface of the transducer, this reduces the efficiency of the deflection and reduces the beam steering accuracy. While keeping the transducers size small, a larger number of transducers are used to cover more of the surface of the crystal.

The size of the transducers may be selected for the best effect in a particular application. Let L, w and t be the length, width and thickness of a transducer, respectively. Since t generally does not affect the acoustic interference in the crystal, only L and w need to be used to quantify the relative size, small or large, of the transducer. If L>>w, i.e., L=100 w, the transducer can be considered infinitely long in theory and the length dimension will not affect the formation of the acoustic lobes. If L≈w, both the length and width dimensions will affect the formation of the lobes. A transducer may be considered large if w>10Λ and small if w<10Λ for micro-transducers, where Λ is the wavelength of the acoustic wave in the transducer.

In a third alternate technique, the acoustic transducer array 416 covers the majority of the AOD crystal's bottom side, so that the interfered acoustic waves occupy a large portion of the crystal. This increases the deflection efficiency. In conventional AODs, the phases produced by each transducer are fixed and the acoustic frequency is varied to tilt the atomic planes for deflecting the laser beam. In a third alternate technique, the frequencies and phases of the acoustic waves at each transducer are varied to tilt the atomic planes of the entire crystal for deflecting the laser beam. The flexibility in changing the phase of the acoustic waves generated by each transducer provides a dynamic AOD as shown in FIG. 4. In conventional AODs, the phases φ₁, φ₂, φ₃, . . . , φₙ are fixed and the frequencies f₁, f₂, f₃, . . . , fₙ are varied. However, as indicated by the electrical transducer input signal 406, both the frequencies 432 from f₁, f₂, f₃, . . . , fₙ and the phases 434 from φ₁, φ₂, φ₃, . . . , φₙ may be varied.

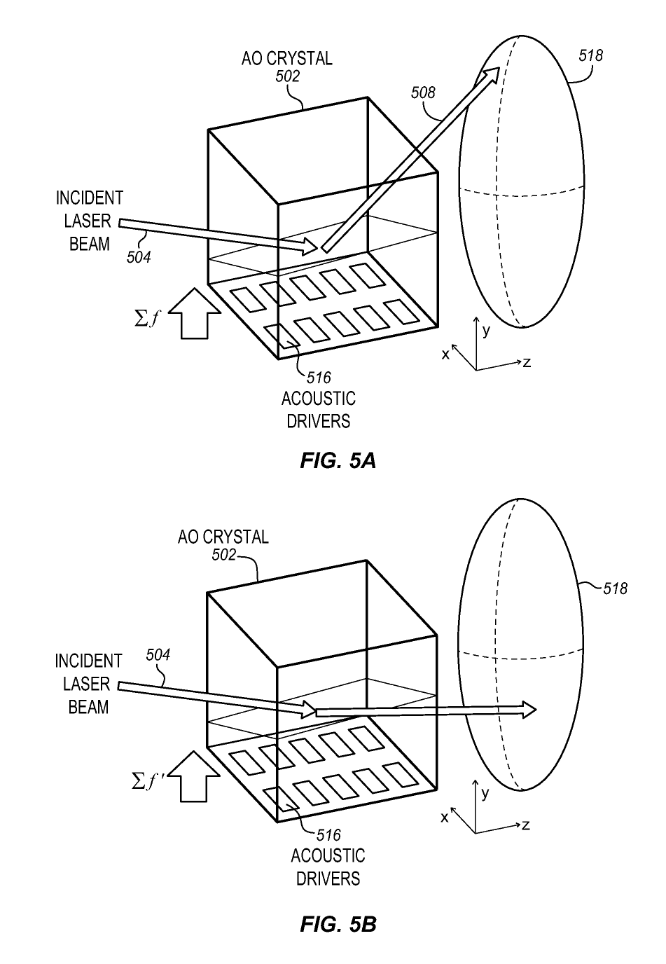

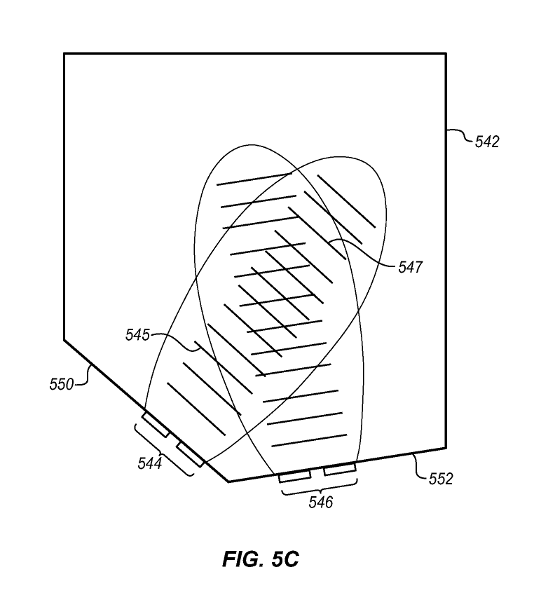

FIG. 5A is a diagram of an AOD that controls the deflection of a beam in two dimensions using a two-dimensional array of transducers on a single face of an AOD crystal. This allows the transducers to be used as a phased array with two degrees of freedom. In FIG. 5A, the incident laser beam 504 enters an AOD crystal 502 where it is deflected at a particular angle determined by the acoustic lobe present in the crystal. The exiting beam 508 is applied to an optical system 518 or a workpiece, depending on the particular implementation. The excited acoustic lobe is generated within the crystal using two-dimensional array 516 of transducers. As shown the transducers may be arranged in a grid with two rows consisting of five transducers in each row. There may be several more rows and more transducers in each row. Large numbers of transducers provide more precise control over the direction of the acoustic lobe. The transducers are driven by external electrical signals having particular waveforms that induce the transducers to produce acoustic waves with different phases such as φ₁, φ₂, φ₃, . . . , φₙ from different transducers.

FIG. 5B shows the same components as in FIG. 5A, however, with a different acoustic waveform applied to the transducer array 516. The laser beam 510 exits the crystal 502 at a different angle to be incident on the lens 518 in a different location.

By applying a set of combinations of frequencies of RF signals with an appropriate phase-shift between neighboring transducer elements, the atomic planes inside AOD crystal are tilted in two dimensions. This mechanism deflects an incident laser beam at a particular angle, which is shown to be upward in FIG. 5A, depending on the tilt-angle of the atomic planes and, consequently, the deflected laser beam is incident on a particular area at the surface of the focusing optics.

By applying a different set of combinations of frequencies of the RF signal with a different phase-shift between neighboring transducer elements, the atomic planes inside the AOD crystal are tilted in a different direction. In the example of FIG. 5B, the incident laser beam is deflected downwards to incident on the surface of the focusing optics at a different location.

As described, phase delays between adjacent acoustic transducers modify the propagation direction of the acoustic wave in the AOD crystal. This change in the propagation direction is utilized to steer an optic beam at the Bragg condition. In some embodiments, in order to have efficient interference for acoustic beam steering, the maximum pitch of the transducers is determined by the desired maximum operating steering angle:

$${P}_{cr} = \frac{{λ}_{S}}{1 + {sin ( {θ}_{s} )}_{ma x}} .$$

where P_{cr} refers to the transducer pitch which is the distance between the centers of two consecutive transducers. In the described examples, the transducer pitch is the same between all adjacent transducers, however, the pitch may be varied with appropriate modifications of the phase delay.

For every light beam steering angle, there is a specific RF frequency with a specific phase-shift between neighboring transducers. This causes the atomic planes of the crystal to be tilted to meet the Bragg condition. The tilting can be increased by increasing the phase-shift between neighboring transducers until the angle is so great that total internal reflection occurs. If the laser beam is incident on the exit surface of the AOD crystal at an incidence angle larger than the critical angle, θ_{cr}, then total internal reflection occurs.

The transducers can be placed at the bottom surface of the acousto-optic crystal in any of a variety of different configurations. In FIG. 5A, a planar phased array of transducers is placed on a single plane of the crystal. FIG. 5C shows another example in which a tilted phased array of transducers is placed on two different planes of a crystal.

In FIG. 5C, an AOD crystal 542 has two adjacent angled faces 550, 552. More than two angled faces can be utilized if needed. Each of these two faces has an acoustic transducer array 544, 546 which drive acoustic waves 545, 547 into the crystal in different directions. The angle between the tilted transducer arrays need to match the center frequencies each transducer array, so that Bragg condition can be met in a wider frequency bandwidth. This configuration provides larger deflection angle, better use of the acoustic energy and additional control of the width (W) of the steering lobe.

Beam steering using a single AOD with a 2-D phased array transducer reduces system complexity and increases production speed for many systems that use a laser for manufacturing, such as laser via drilling and laser direct imaging. The AOD provides better beam positioning because there are no mechanical moving parts. More accurate positioning allows features to be formed with higher accuracy. As an example connection bumps on surface of a die may be formed more accurately allowing them to be closer together. This allows for higher bump pitches and higher input-output densities in the manufactured device.

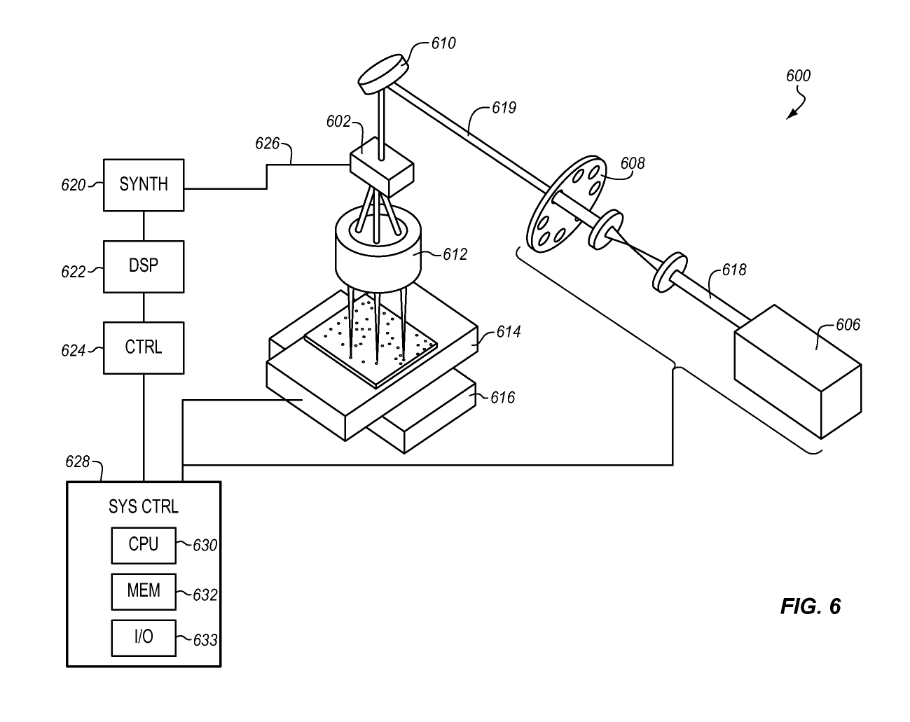

FIG. 6 is a diagram of a semiconductor substrate processing system 600 using an acousto-optic deflector. A laser beam 619 is deflected by an acousto-optic deflector 602 to be incident on a workpiece 616 for fabrication and processing applications in accordance with certain embodiments. The workpiece may be a semiconductor, optical, micro-machine or hybrid substrate upon which circuits or machines are produced. The substrate may be made of silicon, gallium arsenide, metal, glass, plastic, resin or a variety of other materials. While the present invention is described in the context of laser drilling in an organic substrate, the invention is not so limited.

The laser beam 618 is first generated from a laser resonator 606 and then optionally passed through an aperture mask 608, to a mirror 610. The mirror directs the received masked laser beam 619 to the acousto-optic deflector 602. The mirror may be fixed or steerable to direct the beam to the acousto-optic deflector at different angles of incidence. From the acousto-optic deflector, the laser beam emerges at different angles into a scanning lens 612 such as a telecentric lens to focus and direct the beam onto the workpiece 616. The workpiece is placed on a support such as a pedestal, a chuck, or a scanning X-Y table 614. The laser is then used to drill vias, expose photoresist for photolithography, perform detection and test routines with the addition of a camera or other imaging system (not shown) or perform a variety of other tasks on the workpiece.

The angle at which the laser beam emerges from the acousto-optic deflector is controlled by electrical input signals 626 that are generated by a frequency synthesizer 620. The frequency synthesizer is coupled to each of the transducers of the acousto-optic deflector so that the phase, frequency, and amplitude of the electrical drive signal to each transducer may be controlled by one general signal or independently controlled. The frequency synthesizer is coupled to a DSP (Digital Signal Processor) that generates appropriate signals for producing the frequency, phase delay and other parameters required to run the transducers. The DSP is controlled by a controller 624 which receives inputs from a system controller 628 that guides the fabrication process on the workpiece. The system controller also controls the scanning table 614, laser resonator 606, aperture mask 608 and other components (not shown).

The system controller 628 includes electronic components to allow it to control the fabrication process involving all of the illustrated components and others used for fabrication. These other components include, but are not limited to, a central processor 630, memory 632 which may be a volatile memory (e.g., DRAM), non-volatile memory (e.g., ROM), flash memory, mass storage, or some combination of different memory types and input/output components 633 to allow wireless and/or wired communications for the transfer of data and commands to and from the system controller.

Depending on its other functions, the system controller may include other components that may or may not be physically and electrically coupled to a system board. These may include a graphics processor, a digital signal processor, a chipset, an antenna, and a display.

The laser resonator 606 generates laser beams 618 which are then passed through the aperture mask 608 to provide different specific sizes and shapes depending on the requirements of the work being performed on the workpiece. The aperture mask 608 rotates to present different shaped apertures that shape the laser beam 618 into predefined shapes depending on the work that is to be performed, for example laser drilling of holes in different shapes. Optical elements modify the beam. The modifications may include one or more of the following: modification of the laser irradiance; modification of the irradiance profile (beam shaping); modification of the physical shape (circular versus rectangular cross-section of the beam); and modification of the size of the beam. The shaped laser beam 620 is directed to a mirror. The mirror 610 optically reflects the shaped laser beam 620 that is generated by the aperture mask 608.

The optical system 616 between the acousto-optic deflector and the workpiece may take a variety of different forms depending on the workpiece and the work to be performed. FIG. 3 shows a single telecentric lens. This lens directs the laser beam to a position on the workpiece based on the angle of incidence of the beam on the lens. The same optical effect may be performed using more optical elements or different types of optical elements to meet the packaging needs, space limitations, frequency limitations, and other design constraints. Magnification optics may also be used to modify the beam before it reaches the workpiece. The magnifier may be used to increase the spatial area on which the laser beams are projected on the two-dimensional plane. The magnification optics may be an optical system that increases the area over which the laser beams are allowed to incident.

The system may be equipped with a beam splitter (not shown) in different locations so that a single laser source may be used to deliver multiple beams to the workpiece. The beam splitters may be used to deliver the laser to multiple acousto-optic deflectors for controlling multiple beams independently and simultaneously. Alternatively, the beam splitters may be used to divide the deflected or steered beam into multiple beams for simultaneously processing multiple locations of the same workpiece with a single acousto-optic deflector.

Additionally, multiple acousto-optic deflectors (not shown) may be included in the system to increase the angular range of the overall system or to achieve additional degrees of freedom in steering the laser beam. The additional acousto-optic deflectors may be oriented differently from the first one to cause different effects.

Any currently existing laser techniques may be used with the laser steering system of FIG. 6 to produce similar effects, including amplitude modulation, beam switching in the temporal dimension, diffusion, focusing, and frequency shifts.

Because the acousto-optic deflector described herein may be used to deflect the laser beam in two dimensions simultaneously using phase delays between each of multiple transducers, the steered beam may be moved across the workpiece in two dimensions. As a result, the workpiece may be supported on a simple support system that provides movement in the same way as an X -Y table or scanning table. Alternatively, depending on the size of the workpiece and the total X-Y range of the laser beam steering system, the table may be configured to supply one part of the workpiece without moving the workpiece After this part is processed, the table may move to supply another part of the workpiece. For each part of the workpiece, the laser beam may be steered to reach all the desired points on the part until the intended processes are completed.

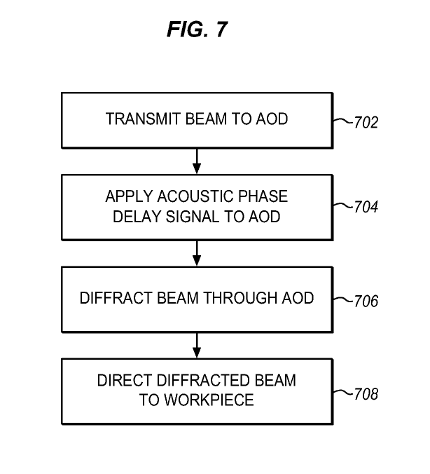

FIG. 7 is a process flow diagram that may be used for the present application. At 702, an optic beam such as a beam of laser light is transmitted to an AOD. As mentioned above, the beam may be shaped with an aperture mask or guided by a mirror or other optics. The beam may also be narrowed, broadened, focused, split, or manipulated in other ways. At 704, an acoustic phase delay signal is applied to the AOD. The phase delay is applied to the transducers that are attached to the AOD to produce an acoustic lobe within the AOD. The phase delay may be induced in one or more directions of the transducer array to control the position of the acoustic lobe in one or more directions. The electrical signals are applied to the transducers by a signal generator or multiple signal generators such as a frequency synthesizer as shown, for example in FIG. 6, to produce the required acoustic waves for the acousto-optic crystal.

At 706, the AOD receives the beam and diffracts it along one or more axes, depending on the intended direction of the diffracted beam and the acoustic signal from the transducers. At 708, the diffracted beam is directed to a workpiece. The beam may be directed using focusing optics, magnifying optics, minors, or a variety of other devices. The beam may be directed simply by the position of the AOD relative to the workpiece and the angle at which the beam leaves the AOD.

The beam may be directed to the workpiece for via drilling on a substrate, laser scanning, laser direct imaging or other applications. In certain embodiments, beam splitters or beam switching devices are employed to increase the number of laser beams employed for via drilling. In certain embodiments, magnification optics is employed to increase the spatial scanning range of laser beams for via drilling beyond that provided by the AODs. In certain embodiments, electrical inputs to transducers of acousto-optic deflectors are adjusted to modify the phase delay, the power, and the acoustic frequencies emitted by the transducers to control the Bragg angle of diffraction for deflecting the laser beam without employing any mechanical motion, i. e., mechanically-moving component, to deflect the laser beam.

In the description, a laser beam is used as an example of the type of optic beam that may be used with the described embodiments of an AOD. Any coherent or incoherent optic beam may be used including e-beams and microwave beams, depending on the intended use of the deflected beam. The crystal material of the AOD may be modified to suit different wavelengths of the beam. For a typical CO₂ laser, a germanium crystal may be used but other crystals may also be used to suit different wavelengths of the light that is incident on the AOD crystal. The crystal may be isotropic, such as germanium or anisotropic, such as tellurium dioxide. A variety of different crystal material and laser types may be used to suit different applications of the deflected beam.

As an alternative to the germanium crystal described here which is particularly effective for light from 2-12 μm, typical of, for example a CO₂ laser, other materials may be used. Gallium phosphide is particularly effective for light from 0.6-10 μm. Tellurium dioxide is particularly effective for light from 0.35-5 μm. Indium phosphide is particularly effective for light from 1-1.6 μm. Fused quartz is particularly effective for light from 0.2-4.5 μm. Other materials may be used instead of these depending on the desired wavelengths for the light and the desired acousto-optic effect.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicates that different instances of like elements are being referred to, and are not intended to imply that the elements so described must be in a given sequence, either temporally, spatially, in ranking, or in any other manner.

The drawings and the descriptions are examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. Various features of the different embodiments may be variously combined with some features included and others excluded to suit a variety of different applications. Some embodiments pertain to a method that includes transmitting an optic beam through an acousto-optic deflector, applying an acoustic signal with a phase delay across multiple transducers of the acousto-optic deflector to deflect the beam along a first axis by the acousto-optic deflector, and directing the deflected beam onto a workpiece.

Further embodiments include deflecting the beam simultaneously along a second axis by the acousto-optic deflector.

In further embodiments, the transducers are arranged in two dimensions and wherein applying the acoustic signal comprises applying the acoustic signal with a phase delay in the two dimensions of the transducers to control the deflection of the beam along the first and the second axis. The workpiece is a substrate, the method further comprising focusing the deflected optic beam through magnification optics onto the substrate to drill vias on the substrate.

Further embodiments include adjusting the frequencies of the applied acoustic signal to control an angle of deflection of the optic beam.

In further embodiments the multiple transducers are along a single first surface of the acousto-optic deflector, the method further comprising applying a second acoustic signal to a second set of multiple transducers arranged on a second surface of the acousto-optic deflector, the first and the second surfaces being adjacent so that an acoustic wave in the crystal from the first surface combines with an acoustic wave in the crystal from the second surface.

Further embodiments include transmitting the optic beam through an aperture mask, reflecting the transmitted (masked) optic beam by a minor to the acousto-optic deflector, positioning the workpiece on a surface so that the deflected optic beam is incident on the substrate, and drilling vias on the substrate by the diffracted optic beam of the acousto-optic deflector.

Further embodiments pertain to a system having an acousto-optic deflector having a first surface configured to receive a transmitted optic beam and a second surface, a plurality of acoustic transducers on the second surface of the acousto-optic deflector, an electrical input for the acoustic transducers configured to generate an acoustic frequency signal using the transducers with a selected phase delay between each transducer, and to apply the acoustic frequency signal to the acousto-optic deflector to control an angle of deflection of the optic beam along a first axis, and imaging optics to direct the deflected optic beam to a workpiece.

In further embodiments the plurality of acoustic transducers are arranged in two dimensions and wherein the electric input is configured to generate an acoustic frequency signal using the transducers with two sets of selected phase delays between the transducers, the first set of phase delays being in a first of the two dimensions of the transducers and the second set of phase delays being in a second of the two dimensions of the transducers to simultaneously control a deflection of the optic beam along the first and the second axis. The two dimensions of the transducers are orthogonal. The transducers are arranged in a grid array with the transducers positioned in orthogonal rows. The first and the second surfaces of the acousto-optic deflector are orthogonal.

Further embodiments include a second plurality of acoustic transducers on a third surface of the acousto-optic deflector, and wherein the electrical input is further applied to the second plurality of acoustic transducers to generate a second acoustic frequency signal with a selected phase delay between each transducer, and to apply the acoustic frequency signal to the acousto-optic deflector to control an angle of deflection of the optic beam also along a second axis.

In further embodiments, the imaging optics comprises a telecentric lens. The optic beam is to produce vias on the workpiece. The optic beam is to expose a photo-resist material for laser direct imaging to fabricate a circuit on the workpiece. The electrical input is adjusted to change acoustic frequencies across the transducers to control an angle of deflection of the optic beam. The electrical input is adjusted by changing the phase delay between adjacent transducers. The electrical input is adjusted by changing the power applied to the transducers. The electrical input is adjusted to change acoustic frequencies across the transducers to achieve the Bragg condition for diffracting the optic beam under the Bragg condition. The acousto-optic deflector comprises a germanium crystal. The acousto-optic deflector comprises a tellurium dioxide crystal.

Further embodiments pertain to a system for via drilling on a substrate, the system includes a laser resonator configured to generate a laser beam, an aperture mask optically coupled to the laser resonator to shape the laser beam, an acousto-optic deflector configured to receive the laser beam, and to steer the received laser beam in an intended direction, an optical element to direct the steered laser beam, and a workpiece support to which the steered laser beam is directed to work on a supported workpiece.

In further embodiments the acousto-optic deflector has a plurality of acoustic transducers on a surface of the acousto-optic deflector and wherein the transducers receive an acoustic frequency electric signal with a phase delay between the transducers to control the direction of the steered laser beam.

In further embodiments the plurality of acoustic transducers are arranged in two dimensions and wherein the electric input is configured to generate an acoustic frequency signal using the transducers with two sets of selected phase delays between the transducers, the first set of phase delays being in a first of the two dimensions of the transducers and the second set of phase delays being in a second of the two dimensions of the transducers to simultaneously control a deflection of the laser beam along the first and the second axis.

In further embodiments the acousto-optic deflector has a second plurality of acoustic transducers on a second surface of the acousto-optic deflector and wherein the second plurality of acoustic transducers receive a second acoustic frequency electric signal with a phase delay between the transducers to control the direction of the steered laser beam along a second axis.

In further embodiments work on the supported workpiece comprises drilling vias on the workpiece. Work on the supported workpiece comprises exposing a photoresist material for laser direct imaging. Electrical inputs to the transducers are adjusted to change acoustic frequencies to control an angle of diffraction to deflect the laser beam. Electrical inputs to the transducers are adjusted to change acoustic frequencies across the transducers to achieve the Bragg condition for deflecting the laser beam under the Bragg condition.

In further embodiments multiple transducers are arranged on multiple faces of the acousto-optic deflector with certain angle between faces.

What is claimed is:

1. A method comprising:
transmitting an optic beam through an acousto-optic deflector;
applying an acoustic signal with a phase delay across multiple transducers of the acousto-optic deflector to deflect the beam along a first axis by the acousto-optic deflector; and
directing the deflected beam onto a workpiece.

2. The method of claim 1, further comprising deflecting the beam simultaneously along a second axis by the acousto-optic deflector.

3. The method of claim 2, wherein the transducers are arranged in two dimensions and wherein applying the acoustic signal comprises applying the acoustic signal with a phase delay in the two dimensions of the transducers to control the deflection of the beam along the first and the second axis.

4. The method of claim 1, wherein the multiple transducers are along a single first surface of the acousto-optic deflector, the method further comprising applying a second acoustic signal to a second set of multiple transducers arranged on a second surface of the acousto-optic deflector, the first and the second surfaces being adjacent so that an acoustic wave in the crystal from the first surface combines with an acoustic wave in the crystal from the second surface.

5. The method of claim 1, the method further comprising:
transmitting the optic beam through an aperture mask;
reflecting the transmitted (masked) optic beam by a minor to the acousto-optic deflector;
positioning the workpiece on a surface so that the deflected optic beam is incident on the substrate; and
drilling vias on the substrate by the diffracted optic beam of the acousto-optic deflector.

6. A system, comprising:
an acousto-optic deflector having a first surface configured to receive a transmitted optic beam and a second surface;
a plurality of acoustic transducers on the second surface of the acousto-optic deflector;
an electrical input for the acoustic transducers configured to generate an acoustic frequency signal using the transducers with a selected phase delay between each transducer, and to apply the acoustic frequency signal to the acousto-optic deflector to control an angle of deflection of the optic beam along a first axis; and
imaging optics to direct the deflected optic beam to a workpiece.

7. The system of claim 6, wherein the plurality of acoustic transducers are arranged in two dimensions and wherein the electric input is configured to generate an acoustic frequency signal using the transducers with two sets of selected phase delays between the transducers, the first set of phase delays being in a first of the two dimensions of the transducers and the second set of phase delays being in a second of the two dimensions of the transducers to simultaneously control a deflection of the optic beam along the first and the second axis.

8. The system of claim 7, wherein the transducers are arranged in a grid array with the transducers positioned in orthogonal rows.

9. The system of claim 6, further comprising a second plurality of acoustic transducers on a third surface of the acousto-optic deflector, and wherein the electrical input is further applied to the second plurality of acoustic transducers to generate a second acoustic frequency signal with a selected phase delay between each transducer, and to apply the acoustic frequency signal to the acousto-optic deflector to control an angle of deflection of the optic beam also along a second axis.

10. The system of claim 6, wherein the electrical input is adjusted to change acoustic frequencies across the transducers to control an angle of deflection of the optic beam.

11. The system of claim 10, wherein the electrical input is adjusted by changing the phase delay between adjacent transducers.

12. The system of claim 10, wherein the electrical input is adjusted by changing the power applied to the transducers.

13. The system of claim 6, wherein the electrical input is adjusted to change acoustic frequencies across the transducers to achieve the Bragg condition for diffracting the optic beam under the Bragg condition.

14. The system of claim 6, wherein the acousto-optic deflector comprises a germanium crystal.

15. The system of claim 6, wherein the acousto-optic deflector comprises a tellurium dioxide crystal.

16. A system comprising:
a laser resonator configured to generate a laser beam;
an aperture mask optically coupled to the laser resonator to shape the laser beam;
an acousto-optic deflector configured to receive the laser beam, and to steer the received laser beam in an intended direction;
an optical element to direct the steered laser beam; and
a workpiece support to which the steered laser beam is directed to work on a supported workpiece.

17. The system of claim 16, wherein the acousto-optic deflector has a plurality of acoustic transducers on a surface of the acousto-optic deflector and wherein the transducers receive an acoustic frequency electric signal with a phase delay between the transducers to control the direction of the steered laser beam.

18. The system of claim 17, wherein the plurality of acoustic transducers are arranged in two dimensions and wherein the electric input is configured to generate an acoustic frequency signal using the transducers with two sets of selected phase delays between the transducers, the first set of phase delays being in a first of the two dimensions of the transducers and the second set of phase delays being in a second of the two dimensions of the transducers to simultaneously control a deflection of the laser beam along the first and the second axis.

19. The system of claim 17, wherein the acousto-optic deflector has a second plurality of acoustic transducers on a second surface of the acousto-optic deflector and wherein the second plurality of acoustic transducers receive a second acoustic frequency electric signal with a phase delay between the transducers to control the direction of the steered laser beam along a second axis.

20. The system of claim 16, wherein electrical inputs to the transducers are adjusted to change acoustic frequencies across the transducers to achieve the Bragg condition for deflecting the laser beam under the Bragg condition.
